(19) United States
(12) Patent Application Publication
(10) Pub. No.: US 2024/0195513 A1
(43) Pub. Date: Jun. 13, 2024

(54) TRANSMITTING DATA OVER AUDIO USING SEGMENTED PAYLOADS AND SEGMENTED RETRANSMISSION

(71) Applicant: LISNR, INC, Cincinnati, OH (US)

(72) Inventor: Oz MENDEL, Piedmont, CA (US)

(21) Appl. No.: 18/538,560

(22) Filed: Dec. 13, 2023

Related U.S. Application Data
(60) Provisional application No. 63/432,193, filed on Dec. 13, 2022.

(51) Int. Cl. H04B 11/00; H04L 1/1607

(52) U.S. Cl. CPC H04B 11/00; H04L 1/1657

(57) ABSTRACT

Systems and methods for improved audio transmission of data payloads using segmented payloads are provided. In one embodiment, a method is provided that includes receiving data for transmission and dividing the data into multiple data segments. One or more headers may be appended to the data segments and used to form a first audio transmission. The first audio transmission may be transmitted as an audio signal within the audio environment. Another computing device may receive the audio transmission and may determine that the audio transmission contains a segmented data payload. In response, the computing device may identify segment headers within the audio transmission and may extract payload segments from the audio transmission based on the segment headers. A plurality of data segments may then be extracted from the payload segments.

### CROSS REFERENCE TO RELATED APPLICATIONS

This application claims the benefit of priority to U.S. Provisional Application 63/432,193 filed Dec. 13, 2022, which is incorporated herein by reference in its entirety.

### BACKGROUND

Data often needs to be transmitted between computing devices without connecting both devices to the same computing network. For example, in certain applications, a computing network may not exist near the computing devices, or it may be too cumbersome (e.g., may take too long) to connect one or both of the computing devices to a nearby computing network. Therefore, data may be transmitted directly from one computing device to another.

In some instances, it may be desirable to transmit data between computing devices without connecting both devices to the same computing network to enable identification of a person, or group of persons, located in particular proximity to one or more of the devices.

### SUMMARY

The present disclosure presents new and innovative systems and methods for communicating with audio transmissions that contain segmented payloads. In some aspects, the techniques described herein relate to a method including: receiving data for transmission within an audio environment; dividing the data into a plurality of data segments; appending a plurality of headers to the plurality of data segments to form a first audio transmission; and transmitting the first audio transmission as a first audio signal within the audio environment.

In some aspects, the techniques described herein relate to a method, further including, after transmitting the first audio transmission: receiving, within the audio environment, a second audio transmission containing an acknowledgment of the first audio transmission; and determining, based on the second audio transmission, that a subset of the plurality of data segments were not received.

In some aspects, the techniques described herein relate to a method wherein the acknowledgment contains identifiers of received data segments, and wherein the subset of the plurality of data segments that were not received are identified based on the identifiers.

In some aspects, the techniques described herein relate to a method further including: generating a third audio transmission containing the subset of the plurality of data segments and transmitting the third audio transmission as a second audio signal within the audio environment.

In some aspects, the techniques described herein relate to a method wherein the plurality of headers include a main header before a first data segment of the plurality of data segments and a plurality of segment headers before at least a subset of the plurality of data segments.

In some aspects, the techniques described herein relate to a method wherein the main header indicates (i) a segment length for the plurality of data segments and/or (ii) a quantity of the plurality of data segments.

In some aspects, the techniques described herein relate to a method wherein the plurality of segment headers are generated individually for each corresponding segment.

In some aspects, the techniques described herein relate to a method wherein each segment header of the plurality of segment headers is generated to contain an identifier of a subsequent data segment.

In some aspects, the techniques described herein relate to a method wherein each segment header of the plurality of segment headers is generated based on a subsequent data segment.

In some aspects, the techniques described herein relate to a method wherein each of the plurality of headers includes a training sequence.

In some aspects, the techniques described herein relate to a method wherein transmitting the first audio transmission as a first audio signal includes: modulating contents of the first audio transmission into a plurality of audio symbols and generating an audio signal containing the plurality of audio symbols.

In some aspects, the techniques described herein relate to a method wherein a size of the data for transmission is greater than or equal to 256 bytes.

In some aspects, the techniques described herein relate to a system including a processor and a memory storing instructions which, when executed by the processor, cause the processor to: receive data for transmission within an audio environment; divide the data into a plurality of data segments; append a plurality of headers to the plurality of data segments to form a first audio transmission; and transmit the first audio transmission as a first audio signal within the audio environment.

In some aspects, the techniques described herein relate to a method including: detecting a first audio transmission within a received audio signal; determining, based on a main header of the first audio transmission, that the audio transmission contains a plurality of data segments; identifying, within the first audio transmission, a plurality of segment headers; extracting, from the received audio signal, a plurality of payload segments based on the segment headers; and extracting, based on the segment headers, the plurality of data segments from the plurality payload segments.

In some aspects, the techniques described herein relate to a method wherein extracting the plurality of data segments includes: determining that at least one of the plurality of data segments was not properly received and transmitting a second audio transmission requesting retransmission of the at least one of the plurality of data segments that was not properly received.

In some aspects, the techniques described herein relate to a method wherein the second audio transmission contains an acknowledgment, and wherein the method further includes generating the acknowledgment to include identifiers of data segments of the plurality of data segments that were properly received.

In some aspects, the techniques described herein relate to a method further including receiving a third audio transmission that contains the at least one of the plurality of data segments that was not properly received.

In some aspects, the techniques described herein relate to a method wherein the main header indicates a segment length for the plurality of data segments and/or a quantity of the plurality of data segments.

In some aspects, the techniques described herein relate to a method wherein each of the plurality of headers includes a training sequence.

In some aspects, the techniques described herein relate to a method wherein the plurality of segment headers are identified based on the training sequence.

In some aspects, the techniques described herein relate to a method wherein extracting the data from the plurality of payload segments includes equalizing the plurality of payload segments based on a preceding segment header.

In some aspects, the techniques described herein relate to a method wherein the plurality of payload segments are extracted as portions of the audio signal between consecutive segment headers.

In some aspects, the techniques described herein relate to a method wherein the plurality of payload segments are extracted to include corresponding segment headers.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes and not to limit the scope of the disclosed subject matter.

### BRIEF DESCRIPTION OF THE FIGURES

FIG. 1 illustrates a system according to an exemplary embodiment of the present disclosure.

FIG. 2 illustrates an audio transmission according to an exemplary embodiment of the present disclosure.

FIG. 3 illustrates a scenario according to an exemplary embodiment of the present disclosure.

FIG. 4 illustrates a scenario according to an exemplary embodiment of the present disclosure.

FIG. 5 illustrates an audio transmission scenario according to an exemplary embodiment of the present disclosure.

FIG. 6 illustrates a system for communicating using audio transmissions according to an exemplary embodiment of the present disclosure.

FIGS. 7A-7B illustrate data transmission and data receipt operations according to an exemplary embodiment of the present disclosure.

FIGS. 8A-8B illustrate an audio transmission and acknowledgment according to an exemplary embodiment of the present disclosure.

FIG. 9 illustrates a method for transmitting data over audio according to an exemplary embodiment of the present disclosure.

FIG. 10 illustrates a method for receiving data over audio according to an exemplary embodiment of the present disclosure.

FIG. 11 illustrates a computing system, according to an exemplary embodiment of the present disclosure.

### DETAILED DESCRIPTION

Various techniques and systems exist to exchange data between computing devices located near one another without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency identification (RFID), Near Field Communication (NFC), and Wi-Fi® (e.g., direct Wi-Fi® links between the computing devices). However, each of these protocols relies on data transmission using electromagnetic waves at various frequencies. Therefore, in certain instances (e.g., ZigBee®, Z-Wave®, ID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired to transmit data according to these wireless communication protocols. Such communicative pairing can be cumbersome and slow, reducing the likelihood that users associated with one or both of the computing devices will utilize the protocols to transmit data.

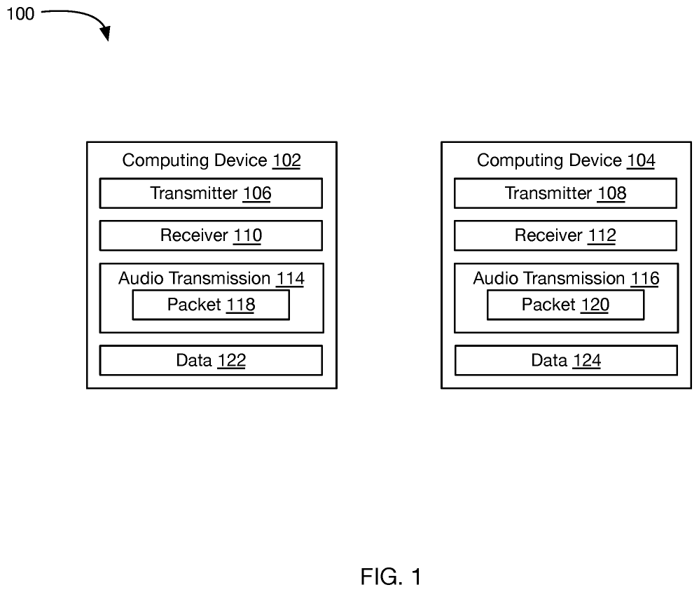

Therefore, there exists a need to wirelessly transmit data in a way that (i) does not require specialized hardware and (ii) does not require communicative pairing prior to data transmission. One solution to this problem is to transmit data using audio transmissions. For example, FIG. 1 illustrates a system 100 according to an exemplary embodiment of the present disclosure. The system 100 includes two computing devices 102, 104 configured to transmit data 122, 124 using audio transmissions 114, 116. In particular, each computing device 102, 104 includes a transmitter 106, 108 and a receiver 110, 112. The transmitters 106, 108 may include any type of device capable of generating audio signals, such as speakers or transducers. In certain implementations, the transmitters 106, 108 may be implemented as a speaker built into the computing device 102, 104. For example, one or both of the computing devices may be a smart phone, tablet computer, and/or laptop with a built-in speaker that performs the functions of the transmitter 106, 108. In other implementations, the transmitters 106, 108 may be implemented as a speaker or transducer external to the computing device 102, 104. For example, the transmitters 106, 108 may be implemented as one or more speakers or transducers externally connected to the computing device 102, 104. In still further implementations, transmitters 106, 108 may be communicatively separate from computing devices.

The receivers 110, 112 may include any type of device capable of receiving audio transmissions and converting the audio transmissions into signals (e.g., digital signals) capable of being processed by a processor of the computing device, such as microphones. In other implementations, the receivers 110, 112 may be implemented as a microphone built into the computing devices 102, 104. For example, one or both of the computing devices may be a smartphone, tablet computer, and/or laptop with a built-in microphone that performs the functions of the receivers 110, 112. In other implementations, the receivers 110, 112 may be implemented as a microphone external to the computing devices 102, 104. For example, the receivers 110, 112 may be implemented as one or more microphones external to the computing devices 102, 104 that are communicatively coupled to the computing devices 102, 104. In certain implementations, the transmitters 106, 108 and receivers 110, 112 may be implemented as a single device connected to the computing device. For example, the transmitters 106, 108 and receivers 110, 112 may be implemented as a single device containing at least one speaker and at least one microphone that is communicatively coupled to the computing devices 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112). In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing device 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmissions 114, 116, the computing devices 102, 104 may modulate the packets 118, 120 onto an audio carrier signal. The computing devices 102, 104 may then transmit the audio transmissions 114, 116 via the transmitters 106, 108, which may then be received by the receivers 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Also, because these techniques can utilize conventional computer hardware like speakers and microphones, the computing devices 102, 104 may not require specialized hardware to transmit the data 122, 124.

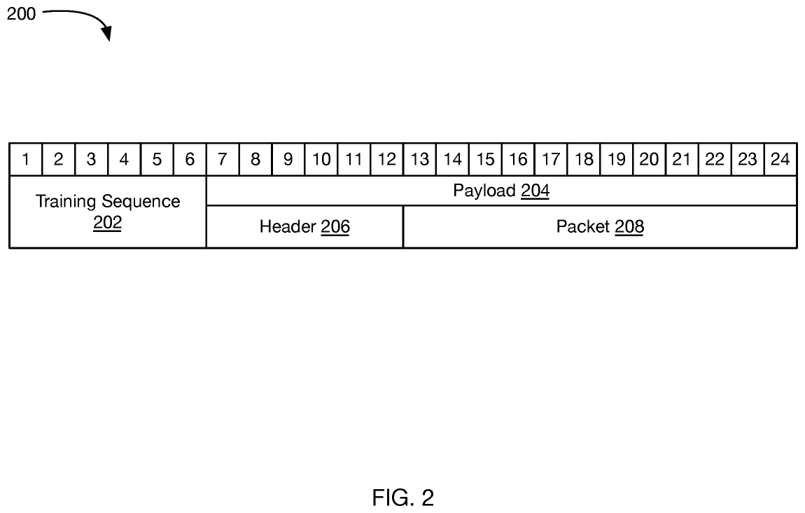

FIG. 2 illustrates an audio transmission 200 according to an exemplary embodiment of the present disclosure. The audio transmission 200 may be used to transmit data from one computing device to another computing device. For example, referring to FIG. 1, the audio transmission 200 may be an example implementation of the audio transmissions 114, 116 generated by the computing devices 102, 104. The audio transmission 200 includes multiple symbols 1-24, which may correspond to discrete time periods within the audio transmission 200. For example, each symbol 1-24 may correspond to 2 ms of the audio transmission 200. In other examples, the symbols 1-24 may correspond to other time periods within the audio transmission 200 (e.g., 1 ms, 10 ms, 20 ms, 40 ms). Each symbol 1-24 may be formed by modulating digital data according to one or more modulation protocols. In particular, the symbols 1-24 may represent combinations of audio frequencies, audio magnitudes, audio phases, and/or audio phase differences (e.g., relative to preceding or successive symbols). The contents of the symbols may be determined based on one or more modulation protocols, such as a phase shift keying (PSK) modulation protocol, a differential phase shift keying (DPSK) modulation protocol, and/or a quadrature amplitude modulation (QAM) modulation protocol.

In particular, certain symbols 1-24 may correspond to particular types of information within the audio transmission 200. For example, the symbols 1-6 may correspond to a training sequence 202, and symbols 7-24 may correspond to a payload 204. The training sequence 202 may contain predetermined symbols produced at predetermined points of time (e.g., by varying one or more of the frequency and the phase in a predetermined manner for the frequencies 1-6). The training sequence 202 may be used to identify the audio transmission 200 to a computing device receiving the audio transmission 200. For example, a receiver of the computing device receiving audio transmissions, such as the audio transmission 200, may also receive other types of audio data (e.g., audio data from environmental noises and/or audio interference). The training sequence 202 may therefore be configured to identify audio data corresponding to the audio transmission 200 when received by the receiver of the computing device. In particular, the computing device may be configured to analyze incoming audio data from the receiver and to disregard audio data that does not include the training sequence 202. Upon detecting the training sequence 202, the computing device may begin receiving and processing the audio transmission 200. The training sequence may also be used to align processing of the audio transmission 200 with the symbols 1-24 of the audio transmission 200. In particular, by indicating the beginning of the audio transmission 200, the training sequence 202 may enable the computing device receiving the audio transmission 200 to properly align its processing of the audio transmission with the symbols 1-24.

The payload 204 may include the data intended for transmission, along with other information enabling proper processing of the data intended for transmission. In particular, the packet 208 may contain data desired for transmission by the computing device generating the audio transmission 200. For example, and referring to FIG. 1, the packet 208 may correspond to the packets 118, 120 which may contain all or part of the data 122, 124. The header 206 may include additional information for relevant processing of data contained within the packet 208. For example, the header 206 may include routing information for a final destination of the data (e.g., a server external to the computing device receiving the audio transmission 200). The header 206 may also indicate an originating source of the data (e.g., an identifier of the computing device transmitting the audio transmission 200 and/or a user associated with the computing device transmitting the audio transmission 200).

Symbols 1-24 and their configuration depicted in FIG. 2 are merely exemplary. It should be understood that certain implementations of the audio transmission 200 may use more or fewer symbols and that one or more of the training sequence 202, the payload 204, the header 206, and/or the packet 208 may use more or fewer symbols than those depicted and may be arranged in a different order or configuration within the audio transmission 200.

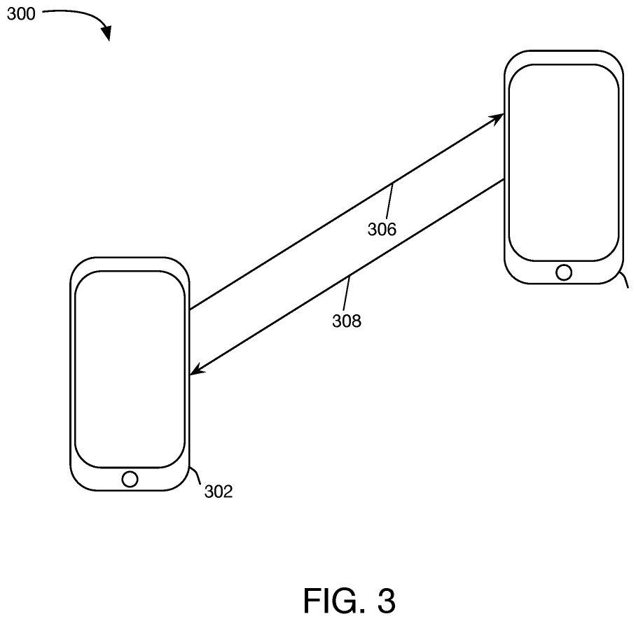

FIG. 3 illustrates a scenario 300 according to an exemplary embodiment of the present disclosure. In the scenario 300, a computing device 302 transmits an audio transmission 306 to the computing device 304. The computing device 304 also transmits an audio transmission 308 to the computing device 302. As depicted, both of the computing devices 302, 304 are mobile devices (e.g., smartphones). Accordingly, the audio transmissions 306, 308 may be transmitted using speakers of the mobile devices and may be received using microphones of the mobile devices. In certain implementations, the audio transmissions 306, 308 may be transmitted at different times. For example, the computing device 302 may transmit the audio transmission 306 before the computing device 304 transmits the audio transmission 308. In other implementations, the audio transmissions 306, 308 may be transmitted at least partially at the same time. In such instances, the audio transmissions 306, 308 may be transmitted on different channels (e.g., using different carrier frequencies), as explained further below.

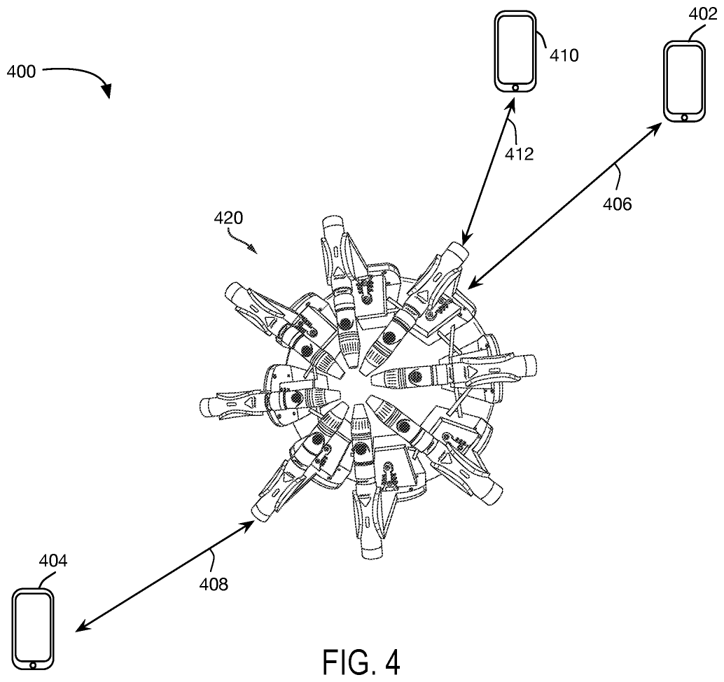

FIG. 4 illustrates another scenario 400 according to an exemplary embodiment of the present disclosure. The scenario 400 includes multiple computing devices 402, 404, 410 communicating with a transmitter/receiver array 420. The transmitter/receiver array 420 includes multiple audio transmitters (e.g., multiple speakers) and multiple audio receivers (e.g., multiple microphones). The transmitter/receiver array 420 may thus be capable of communicating with multiple computing devices 402, 404, 410 at the same time. For example, the transmitter/receiver array 420 may transmit an audio transmission 406 to the computing device 402, receive an audio transmission 412 from the computing device 410, and receive an audio transmission 408 from the computing device 404. In certain instances, the same receiver may receive audio transmissions from multiple computing devices and/or the same speaker may transmit audio transmissions to multiple computing devices. In such instances, different audio channels may be used to transmit and/or receive audio transmissions (e.g., to avoid interference between different communication channels).

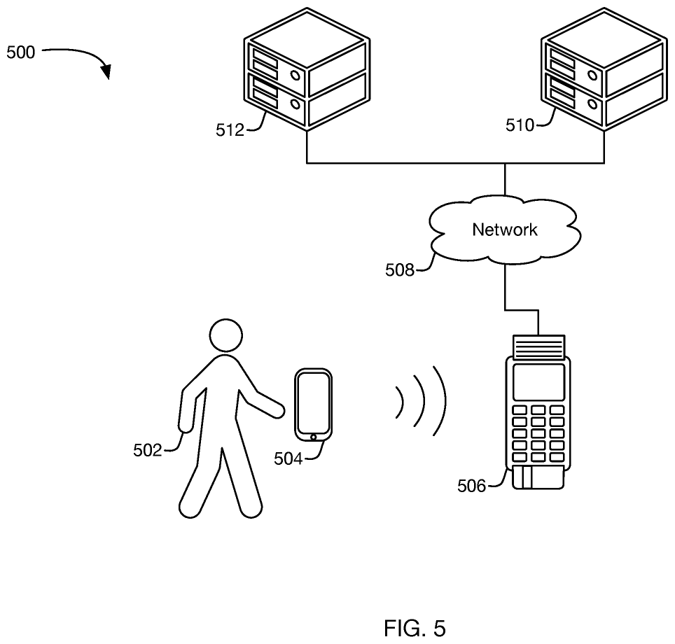

FIG. 5 illustrates an audio transmission scenario 500 according to an exemplary embodiment of the present disclosure. The scenario 500 may take place when a user 502 needs to communicate with a merchant or other service provider. In particular, the user 502 may have a computing device 504 containing data for transmission to another computing device 506 associated with the service provider. For example, the computing device 506 may be a point of sale (POS) device, as depicted. In additional or alternative implementations, the computing device 506 may be implemented as any other type of computing device. The computing device 506 maintains a communicative connection with one or more server devices 510, 512. In particular, the computing device 506 may communicate with one or both of these server devices 510, 512 via the network 508. The server device 510 may be associated with the service provider. The server device 512 may be associated with a third party (e.g., LISNR, Inc) that is configured to provide communication services, such as for communicating using audio transmissions.

In various implementations, the computing device 504 may generate and transmit an audio transmission to the computing device 506. In particular, the computing device 504 may generate and transmit the audio transmission within an audio environment (e.g., the audio environment may include a physical space containing one or more computing devices capable of receiving and/or transmitting data using audio transmissions, such as the computing device 504, 506). The audio environment may include the physical space in which audio transmissions can be transmitted or received and may include one or more sources of audio interference (e.g., individuals, other computing devices, mechanical devices, electrical devices, speakers, and the like).

The computing device 506 may detect and receive the audio transmission within the audio environment (e.g., within audio signals captured from one or more audio receivers positioned within the audio environment). In response, the computing device 506 may communicate (e.g., via the network 508 with the server device 510 associated with the service provider). In particular, the computing device 506 may communicate with the server device 510 to verify and/or validate the information received from the computing device 504 via the audio transmission. In certain implementations, the server device 510 might be configured to communicate with the server device 512 to verify the received information. For example, the audio transmission transmitted by the computing device 504 may contain a data payload constructed by the third party associated with the server device 512 (e.g., constructed using an application programming interface (API) provided by the third party and executing on the computing device 504 and/or the server device 512). In such instances, the server device 510 may not, on its own, be able to validate the received payload. Accordingly, the server device 510 may forward the received payload to the server device 512 (e.g., via the network 508 and/or a separate network connection). The server device 512 may then verify the received information and may transmit a verification result to the server 510, which may communicate the results to the computing device 506. The computing device 506 may then forward the verification results to the computing device 504. Additionally or alternatively, the server device 512 may be configured to directly communicate with one or both of the computing devices 504, 506. For example, when approved, the server device 512 may transmit an approval to both the computing device 504 and the computing device 506.

Upon receiving and processing the information transmitted by the computing device 504, the computing device 506, or another computing device (e.g., the computing device 510) may proceed with fulfilling a request or other service associated with the user 502. For example, the computing device 506 may be located within a retail store, and the user 502 may have previously submitted an order of one or more good for pickup from the retail store. In response to determining that the user 502 has arrived at the retail store (e.g., based on one or more audio transmissions received from the computing device 504), the computing device 506 may proceed with processing payment for the order. Additionally or alternatively, the computing device 506 may transmit one or more notifications to fulfillment personnel (e.g., to bring the user's 502 goods to a pick up counter for delivery to the user 502).

One or more of the above techniques may be used to communicate between multiple computing devices using audio transmissions. However, transmitting data using audio transmissions is not without its shortcomings. In particular, the overall bandwidth of data transmissions over audio may be significantly reduced when compared to alternative, RF-based communication techniques. For example, transmitting data payloads of 256 bytes or more may take on the order of 250-500 milliseconds or more (e.g., up to one second or more). Thus, unlike communications that utilize traditional, RF-based communication interfaces, large data transmissions over audio are significantly more susceptible to forms of audio interference that may degrade the accuracy of received audio transmissions. In particular, over the extended durations necessary to transmit large data payloads over audio, different forms of audio interference (e.g., environmental noise, transmitter movement, receiver movement, other audio transmissions) may adversely impact all or part of a transmitted data payload. Furthermore, given the extended durations involved, the types of interference may change over time during the duration of the audio transmission. Accordingly, techniques designed to remedy a single form of audio interference may be inadequate to correct for the multiple types of interference that may be experienced during large data payload transmissions over audio. Additionally, errors in portions of a large data payload contained within an audio transmission may require retransmitting the entire data payload. Accordingly, errors in large data payload transmissions may compound, as transmissions of a large data payload successively fail and need to be repeated multiple times due to changing audio interference that cannot be properly corrected for over the whole duration of the broadcast.

One solution to this problem is to generate and transmit audio transmissions that contain large data payloads in a segmented manner. In particular, large data payloads for transmission over audio may be divided into multiple data segments, which may be used to form multiple payload segments for an audio transmission. A plurality of headers (e.g., main headers, segment headers) may be appended before at least a subset of the payload segments. Furthermore, a main header may be appended at the beginning of the audio transmission to indicate that the audio transmission contains a segmented payload. The audio transmission may transmit an audio signal within an audio environment that contains the audio transmission. The audio signal may be received by a different computing device. That computing device may analyze the received audio signal to identify the audio transmission. Once identified, the computing device may determine that the audio transmission contains segmented data payloads (e.g., based on one or more indicators contained within the audio transmission). In response, the computing device may extract the data segments from the payload segments within the audio transmission. If the receiving computing device determines that one or more of the received data segments contains an error or was otherwise not properly received, the computing device may request that the transmitting computing device retransmit a portion of the original data payload (e.g., the payload segments containing the erroneous or otherwise corrupted data segments). In particular, the receiving computing device may be configured to generate an acknowledgement in response to receiving the audio transmission, and the acknowledgement may identify all received data segments and/or any missing or improperly received data segments.

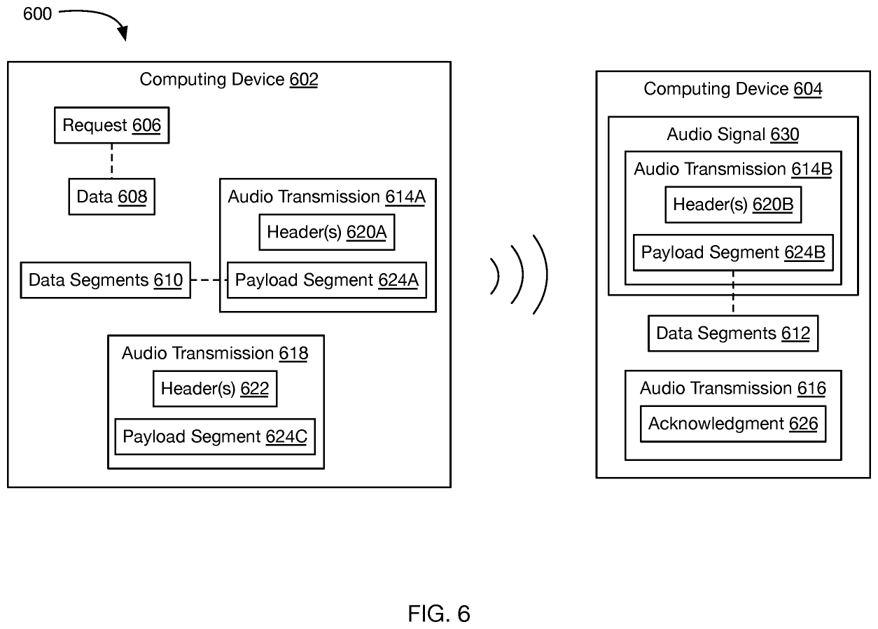

FIG. 6 illustrates a system 600 according to an exemplary embodiment of the present disclosure. The system 600 includes computing devices 602, 604, which may be configured to communicate with one another using audio transmissions. In particular, the computing devices 602, 604 may be configured to communicate using audio transmissions that contain segmented payloads. In the depicted example, the computing device 602 is configured to generate and transmit an audio transmission 614A, and the computing device 604 is configured to receive and process the audio transmission 614B (e.g., a copy of the audio transmission 614A). However, in practice the computing devices 602, 604 may each be configured to both transmit and receive audio transmissions.

The computing device 602 may receive and/or generate data 608 for transmission via audio transmission. The data 608 may contain an identifier of other information necessary to identify the computing device 602 and/or a user of the computing device 602. For example, the data 608 may be used to identify or process a request 606 corresponding to a user of the computing device 602. The request 606 may be a request for a service. The service may include a request to perform a computing service, a location-based service, and/or a financial service. Computing services may include one or more of generating, storing, retrieving, and/or manipulating data (e.g., data associated with a user of the computing device 602). Location-based services may include one or more services in which the user is required to be in a particular location to complete the service (e.g., rideshare services, order pickup and/or delivery services, dog walking services, home cleaning services). Financial services may include creating an order with a retailer, fulfilling an order with the retailer, creating and/or processing a payment on behalf of a user associated with the computing device 602, and the like. The request 606 may be created by the computing device 602 and/or by a user associated with the computing device 602. Additionally or alternatively, a user associated with the computing device 602 may create the request 606 using another computing device (not depicted). In certain instances, the request 606 may not be created by the user but may be created on the user's behalf (e.g., by another user or individual, by an automated computing service).

In certain instances, the data 608 may be large enough that conventional audio transmission communication may not be reliable. For example, the size of the data 608 make exceed one or more predetermined thresholds (e.g., 256 bytes, 512 bytes, 1 kilobyte). The computing device 602 may accordingly be configured to transmit the data 608 using an audio transmission 614A that contains a segmented payload. In particular, the computing device 602 may be configured to automatically generate audio transmissions 614A that transmit received data that exceeds the predetermined threshold.

To generate the audio transmission 614A, the computing device 602 may divide the data 608 into a plurality of data segments 610. The size of the data segments may be predetermined. For example, the computing device 602 may divide the date by 608 into data segments 610 with a predetermined size (e.g., 8 bytes, 16 bytes, 32 bytes, 64 bytes). In additional or alternative implementations, the computing device 602 may be configured to divide the data 608 into a predetermined number of data segments (e.g., 4 segments, eight segments, 16 segments, 32 segments) whose size depends on the size of the data 608.

The audio transmission 614A may be constructed based on the data segments 610. In particular, a plurality of payload segments 624A may be generated based on the data segments 610. For example, each data segment 610 may have a corresponding payload segment 624A within the audio transmission 614A. The audio transmission 614A may also include a plurality of headers 620A. The plurality of headers 620A may include a main header (e.g., serving as a header for the audio transmission 614A as a whole) and/or one or more segment headers (e.g., serving as a header for one or more individual payload segments 624A). In particular, the audio transmission 614A may contain a main header at the beginning of the audio transmission 614A and may have, in certain implementations, one or more segment headers appended between consecutive payload segments 624A.

The audio transmission 614A may then be transmitted within an audio environment. For example, as explained further below, the computing device 602 may generate an audio signal that contains the audio transmission 614A and may broadcast that audio signal (e.g., using one or more audio transmitters) within an audio environment containing the computing device 602 and one or more additional computing devices. The computing device 604 may be located within the same audio environment as the computing device 602 and may receive the audio transmission 614B (which may be a copy of all or part of the audio transmission 614A).

In particular, the computing device 604 may be configured to receive and analyze audio signals 630 from the audio environment and to analyze received audio signals 630 for the presence of one or more audio transmissions 614B (e.g., indicated by the presence of one or more training sequences, such as the training sequence 202). In response to detecting the audio transmission 614B, the computing device 604 may process the corresponding portion of the audio signal 630 to extract data segments 612 contained within the audio transmission 614B. In particular, the computing device 604 may determine (e.g., based on one or more of the headers 620B contained within the audio transmission 614B) that the audio transmission 614B contains a segmented data payload. Accordingly, the computing device at 604 may identify corresponding portions of the audio signal 630 that contain the payload segments 624B.

The computing device 604 may then extract the data segments from the payload segments 624B, as explained further below. The computing device 604 may then analyze the extracted data segments 612. For example, the audio transmission 614B may contain one or more pieces of error detection and correction information for the payload segments 624B. The computing device 604 may analyze the data segments based on this error detection and correction information and may determine that one or more of the data segments 612 were not properly received. For example, one or more of the data segments 612 may be corrupted or otherwise erroneous. As another example, one or more of the data segments 610 originally transmitted with the audio transmission 614A may never have been received within the data segments 612. If the computing device 604 detects these errors (e.g., based on the error detection and correction information) and is unable to correct the detected errors in a particular data segment, the computing device 604 may determine that the data segment was not properly received.

The computing device 604 may be configured to generate and transmit an audio transmission 616 after receiving and processing the audio transmission 614B. In particular, the audio transmission 616 may contain an acknowledgement 626. The acknowledgement 626 may indicate all or part of the information received by the computing device at 604 via the audio transmission 614B. In particular, the acknowledgment 626 may be generated to indicate data segments 612 that have been successfully received by the computing device 604. Additionally or alternatively, the acknowledgement 626 may be generated to indicate data segment 612 that were not successfully received by the computing device 604. The audio transmission 616 may be transmitted as an audio signal within the audio environment.

The computing device 602 may receive the audio transmission 616. In particular, the computing device 602 may be configured to receive and analyze audio signals from the audio environment to detect audio transmissions, similar to the computing device 604. The computing device 602 may extract the acknowledgement 626 from the audio transmission (e.g., as a payload within the audio transmission 616). Based on the acknowledgement 626, the computing device 602 may determine that one or more of the data segments 610 were not accurately received by the computing device 604. According, the computing device 602 may generate an additional audio transmission 618 that contains copies of the payload segments 624C that were not successfully received by the computing device 604. In instances where the payload segments 624C only include a single payload segment, the audio transmission 618 may contain a single header 622 (e.g., a main header). In instances where the payload segments 624C include multiple payload segments, the audio transmission 618 may contain multiple headers (e.g., a main header and one or more segment headers, similar to the audio transmission 614A). After receiving the audio transmission 618 and successfully extracting the payload segments 624C, the computing device may have a complete copy of the data segments 610 and may combine the data segments 610 (e.g., sequentially combine, interleave) to form a copy of the data 608. In certain instances, one or more of the payload segments 624C may not be properly received. In such instances, the computing device 604 may generate and transmit another audio transmission that contains another acknowledgment requesting the computing device 602 to retransmit one or more additional data segments.

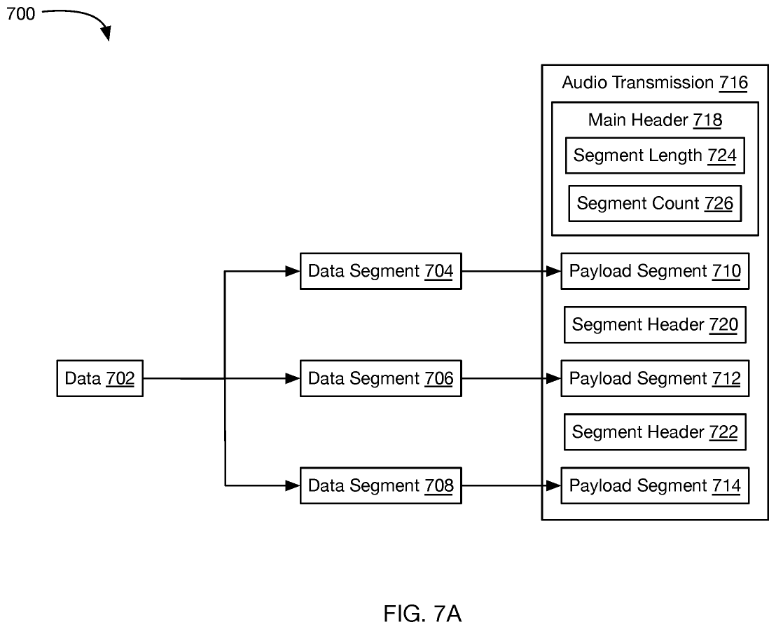

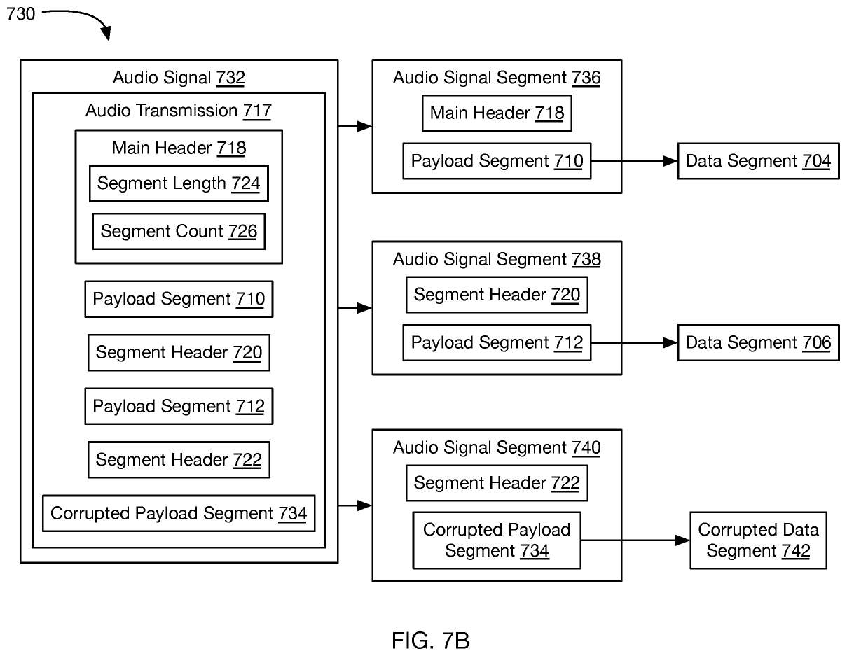

FIGS. 7A-7B illustrate data transmission and data receipt operations 700, 730 according to an exemplary embodiment of the present disclosure. The operations 700, 730 may be exemplary implementations of operations performed by the computing devices 602, 604. For example, the data transmission operation 700 may be an exemplary implementation of an operation performed by the computing device 602 to generate the audio transmission 614A. As another example, the data receipt operation 730 may be an exemplary implementation of an operation performed by the computing device 604 to receive and process the audio transmission 614B. Accordingly, one or more items depicted within FIGS. 7A-7B may correspond to one or more items depicted in FIG. 6. For example, the data 702 may be an exemplary implementation of the data 608, the data segments 704, 706, 708 may be exemplary implementations of the data segments 610, the audio transmission 716 may be an exemplary implementation of the audio transmission 614A, the audio transmission 717 may be an exemplary implementation of the audio transmission 614B, the audio signal 732 may be an exemplary implementation of the audio signal 630, the payload segments 710, 712 and the corrupted payload segments 734 may be exemplary implementations of the payload segment 624B, and the data segments 704, 706 and the corrupted data segment 742 may be exemplary implementations of the data segments 612.

Turning to the operation 700, the data 702 received for transmission may be divided into a plurality of data segments 704, 706, 708. As explained above, the number and/or size of the data segments 704, 706, 708 may be predetermined. As depicted, the data 702 is divided into three data segments 704, 706, 708. However, in additional or alternative implementations, differing numbers of data segments may be used. For example, depending on the size of the data 702, in certain instances, the data 702 will be divided into eight or more segments (e.g., 16 segments, 24 segments, and the like). In one specific example, the data 702 may be 288 bytes in size, and each of the data segments 704, 706, 708 may be 96 bytes in size.

Payload segments 710, 712, 714 may then be generated based on the data segments 704, 706, 708. For example, each data segment 704, 706, 708 may be used to generate a corresponding payload segment 710, 712, 714. In certain instances, the payload segments 710, 712, 714 may only contain copies of the corresponding data segments 704, 706, 708. In additional or alternative implementations, the payload segments 710, 712, 714 may contain additional information. For example, the payload segments 710, 712, 714 may contain error detection and correction information for the corresponding data segments 704, 706, 708. For example, the error detection and correction information may be generated according to various error detection and/or correction protocols. For example, the detection and correction information may be generated based on one or more of a checksum protocol, a cyclic redundancy check (CRC) protocol, an automatic repeat request protocol, a forward error correction protocol, and the like, or any combination of multiple error detection and correction protocols. In particular, the error detection and correction information may be generated as a CRC error checking and correction code for the contents of the data segments 704, 706, 708.

A plurality of headers may additionally be added to the audio transmission 716. For example, the audio transmission 716 includes a main header 718, which may occur at or near the beginning of the audio transmission 716 (e.g., a payload portion of the audio transmission 716). The main header 718 may be generated to indicate that the audio transmission 716 contains a segmented payload. For example, the main header 718 may contain a segmented payload indicator (not depicted). Additionally or alternatively, the main header 718 may contain information on the segmented payload, such as a segment length 724 and/or a segment count 726. The segment length 724 may indicate a length of each of the payload segments 710, 712, 714. The length may be indicated according to one or more length measures (e.g., a quantity of audio symbols, a temporal duration of a corresponding portion of the audio transmission 716, the data size of the corresponding data segment 704, 706, 708, and the like). For example, the segment length 724 may indicate that the payload segments 710, 712, 714 are 100 bytes long (e.g., including 96 bytes of data and four bytes of error checking information). As another example, the segment length 724 may indicate that the payload segments 710, 712, 714 are 100 ms long. The segment count 726 may include an indicator of the total quantity of payload segments 710, 712, 714. For example, as depicted, the segment count 726 may indicate that there are three payload segments 710, 712, 714 within the audio transmission 716.

The headers added to the audio transmission 716 may also include one or more segment headers 720, 722. In particular, the segment headers 720, 722 may be appended between consecutive payload segments 710, 712, 714 within the audio transmission. In particular, the audio transmission 716 contains a segment header 720 between the payload segments 710, 712 and a segment header 722 between the payload segments 712, 714. The segment headers 720, 722 may be added to the audio transmission 716 to indicate a beginning of the subsequent payload segment 712, 714. For example, the segment header 720 may indicate the beginning of the payload segment 712 and the segment header 722 may indicate the beginning of the payload segment 714. In certain instances, the segment headers 720, 722 may contain an identifier of the subsequent payload segment 712, 714. For example, the segment header 720 may contain an identifier of the payload segment 712 and the segment header 722 may contain an identifier of the payload segment 714. In certain implementations, the payload segment identifier may be implemented as a sequence count of the payload segments. For example, a payload segment identifier of the payload segment 712 may indicate that the payload segment 712 is the second payload segment and a payload segment identifier of the payload segment 714 may indicate that the payload segment 714 is the third payload segment within the audio transmission 716. It should be appreciated that, in certain implementations, the main header 718 may additionally contain contents similar to the segment headers 720, 722. For example, the main header 718 may indicate the beginning of the payload segment 710 and may contain an identifier of the payload segment 710 (e.g., as the first payload segments within the audio transmission 716). In additional or alternative implementations, a segment header corresponding to the first payload segment 710 may be appended between the main header 718 and the payload segment 710.

Furthermore, in certain implementations, the main header 718 and/or the segment headers 720, 722 may contain a training sequence. The training sequence may represent a predetermined sequence of audio symbols and may be used by a receiving computing device to equalize a received audio transmission and/or to correct for various forms of audio interference during transmission. Such an implementation may be advantageous, for example, because it allows for repeated equalization and correction of the payload segments 710, 712, 714 which may enable a receiving computing device to correct for changing forms of audio interference over the duration of the audio transmission 716, and which may improve the accuracy of the received version of the audio transmission 716.

Once the audio transmission 716 has been generated, a computing device (e.g., the computing device 602) may transmit the audio transmission 716 within an audio environment as an audio signal. For example, as explained further below, the audio transmission 716 may be modulated into a plurality of audio symbols and an analog audio signal may be generated based on the audio symbols. The audio signal may then be broadcast (e.g., using a speaker or other audio transmitter of the computing device 602) into the audio environment.

Turning to the operation 730, another computing device (e.g., computing device 730) may receive an audio signal 732 from a surrounding audio environment and may detect an audio transmission 717 within the audio signal 732. For example, the computing device may detect the audio transmission 717 based on the presence of a training sequence (e.g., training sequence 202) and/or another predetermined portion contained within the main header 718 or another portion of the audio transmission 717. The audio transmission 717 may represent a received version of the audio transmission 716. In particular, the audio transmission 717 contains the main header 718 and its contents (e.g., a segment length 724, the segment count 726), the payload segments 710, 712, and the segment header 720, 722. However, during transmission of the audio transmission 716, one or more forms of audio interference may have corrupted the payload segment 714 such that it was not properly received within the audio signal 732. Accordingly, the audio transmission 717 as depicted contains a corrupted payload segment 734, which represents the corrupted version of the payload segment 714 as received by the receiving computing device.

After detecting the audio transmission 717, the computing device may determine that the audio transmission 717 contains a segmented payload. For example, the computing device may extract or otherwise analyze the main header 718 and may identify the indicator that the audio transmission 717 contains a segmented payload. In instances where a separate indicator is not included within the main header 718, the computing device may determine, based on the presence of the segment length 724 and/or the segment count 726 within the main header 718, that the audio transmission 717 contains a segmented payload.

After determining that the audio transmission 717 contains a segmented payload, the computing device may extract a plurality of audio signal segments 736, 738, 740 from the audio signal 732 for further processing. In particular, each audio signal segment 736, 738, 740 may be generated to contain one of the payload segments 710, 712, 734 within the audio transmission 717. The locations of the payload segments 710, 712, 734 may be determined based on the segment length 724 and/or the segment count 726. For example, the computing device may determine the number of audio signal segments 736, 738, 740 based on the segment count 726 and may determine a duration of the audio signal segments 736, 738, 740 based on the segment length 724 (e.g., to ensure that the audio signal segments 736, 738, 740 are long enough to contain the corresponding payload segments 710, 712, 734). For example, based on the segment length 724 and the known duration or ending timestamp for the main header 718, an ending timestamp for the audio signal segment 736 may be determined by adding the segment length 724 (or a duration of the payload segment 710 computed based on the segment length 724) to the ending time stamp of the main header 718. The audio signal segment 736 may then be extracted as the portion of the audio signal 732 from the beginning of the main header 718 to the computed ending timestamp. Timestamps may similarly be computed for the audio signal segments 738, 740 based on a known duration (e.g., a predetermined duration or a duration indicated by the main header 718) of the segment headers 720, 722 and the segment length 724. In particular, an ending timestamp for the audio signal segment 738 may be computed by adding the duration of the segment headers and the duration of the payload segments to the ending timestamp for the audio signal segment 736. The audio signal segment 738 may then be extracted as the portion of the audio signal 732 between the ending timestamp for the audio signal segment 736 and the computed ending timestamp for the audio signal segment 738. Similarly, an ending timestamp for the audio signal segment 740 may be computed by adding the duration of the segment headers and the duration of the payload segments to the ending timestamp for the audio signal segment 738. The audio signal segment 740 may then be extracted as the portion of the audio signal 732 between the ending timestamp for the audio signal segment 738 and the computed ending timestamp for the audio signal segment 740. In certain implementations, the audio signal segments 736, 738, 740 may be extracted to contain corresponding headers (e.g., corresponding main headers 718 and/or segment headers 720, 722). In additional or alternative implementations, the audio signal segments 736, 738, 740 may be generated to only contain the corresponding payload segments 710, 712, 734.

The audio signal segments 736, 738, 740 may then be used to extract data segments from the payload segments 710, 712, 734. In particular, the computing device may extract the data segment 704 from the payload segment 710, may extract the data segment 706 from the payload segment 712, and may extract the corrupted data segment 742 from the corrupted payload segment 734. The data segments 704, 706, 742 may be extracted by demodulating the portions of the audio signal segments 736, 738, 740 that contain the payload segments 710, 712, 734 (e.g., according to the modulation protocol used to initially generate the audio signal for the audio transmission 716). In certain implementations, the audio signal segments 736, 738, 740 may be equalized or otherwise corrected before demodulating the payload segments 710, 712, 734. For example, as noted above, the headers 718, 720, 722 may contain a training sequence, and the training sequence may be used to equalize the corresponding audio signal segments 736, 738, 740. In particular, such implementations may enable each of the audio signal segments 736, 738, 740 to be separately equalized according to the audio interference unique to that audio signal segment 736, 738, 740. In certain implementations, the payload segments 710, 712, 734 and/or the headers 718, 720, 722 may contain error correction and detection information for the data segments 704, 706, 708 intended for transmission with the audio transmission 716. In such instances, the error detection and correction information may be used to correct errors in the demodulated data to ensure accurate extraction of the data segments 704, 706. This error detection and correction information may additionally be used to determine that the corrupted data segment 742 is not an accurate copy of the data segment 708 used to generate the payload segment 714. Accordingly, the computing device may determine that the data segment 708 and/or the payload segment 714 was not properly received within the audio transmission 717. The computing device may accordingly generate an acknowledgement to indicate that the third payload segment (e.g., the payload segment 714) was not properly received to indicate that the first and second payload segments (e.g., payload segments 710, 712) were properly received and may transmit that acknowledgement (e.g., as another audio transmission) to the computing device that originally transmitted the audio transmission 716.

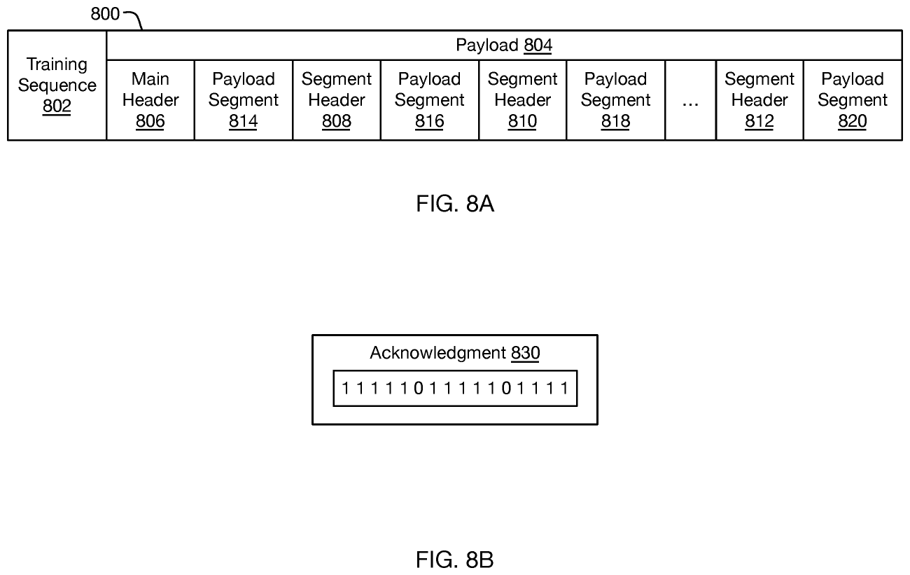

FIGS. 8A-8B illustrate an audio transmission 800 and acknowledgment 830 according to an exemplary embodiment of the present disclosure. The audio transmission 800 may correspond to a representative implementation and/or architecture of audio transmissions with segmented payloads. For example, the audio transmission 800 may be a representative implementation of the audio transmissions 614A, 614B, 618, 716, 717. The acknowledgement 830 may be a representative implementation of an acknowledgement transmitted by a computing device that has received an audio transmission with a segmented payload (e.g., to indicate which payload segments were successfully received and which payload segments were not successfully received). For example, the acknowledgment 830 may be an exemplary implementation of the acknowledgement 626.

Similar to the audio transmission 200, the audio transmission 800 begins with a training sequence 802, which may contain a predetermined audio sequence (e.g., a predetermined analog audio sequence, a predetermined sequence of one or more audio symbols) and may indicate the presence of the audio transmission 800 (e.g., within an audio signal captured of an audio environment surrounding a receiving computing device). The audio transmission 800 contains a payload 804. The payload 804 is segmented, meaning that the data contained within the payload 804 is divided into a plurality of payload segments 814, 816, 818, 820. The payload segments 814, 816, 818, 820 may contain portions of a desired data payload for transmission, as discussed above. The payload 804 also contains multiple headers, which may contain information regarding the audio transmission 800 and the data being transmitted within the audio transmission 800. In particular, the main header 806 may contain routing or other information for the data contained within the payload segments 814, 816, 818, 820, similar to the header 206. Additionally or alternatively, the main header 806 may indicate that the payload 804 is segmented. For example, as discussed above, the main header 806 may include an indicator of the segmented payload, a segment length for the payload segments 814, 816, 818, 820, and/or a segment count 726 indicating the number of payload segments 814, 816, 818, 820. The payload 804 also contains a plurality of segment headers 808, 810, 812. The segment headers 808, 810, 812 are interspersed between consecutive pairs of payload segments 814, 816, 818, 820 within the payload 804. As explained further above, the segment headers 808, 810, 812 may identify corresponding payload segments 816, 818, 820. Additionally or alternatively, the segment headers 808, 810, 812 may contain training sequences used to equalize corresponding portions of a received audio signal containing the payload segments 816, 818, 820.

It should be noted that portions of the audio transmission 800 as depicted in FIG. 8A are not drawn to scale. In particular, different portions of the payload 804 may differ in length. For example, the headers 806, 808, 810, 812 may be shorter in duration than the payload segments 814, 816, 818, 820. Additionally or alternatively, one or more of the payload segments 814, 816, 818, 820 may differ in length from other payload segments 814, 816, 818, 820. Additionally or alternatively, the order and/or contents of the audio transmission 800 may differ. For example, as discussed above, in certain implementations, an additional segment header may occur between the main header 806 and the first payload segment 814. Additionally or alternatively, certain implementations may omit one or more of the segment headers 808, 810, 812.

The acknowledgement 830 may be created by a receiving computing device, such as a computing device that received an audio signal containing the audio transmission 800. Particularly, the acknowledgement 830 may be contained within a second audio transmission that is transmitted by the receiving computing device to a computing device that transmitted the audio transmission 800 to indicate that all or part of the audio transmission 800 was received. In particular, the acknowledgement 830 is generated to indicate which payload segments 814, 816, 818, 820 were successfully received within the audio transmission 800 and which payload segments 814, 816, 818, 820 were not successfully received. For example, the audio transmission 800 may contain a total of 16 payload segments 814, 816, 818, 820. Each of the 16 payload segments may have a corresponding one-bit indicator within the acknowledgement 830. A value of “1” may indicate that the corresponding payload segment was successfully received (e.g., as determined based on error detection and correction information) and a value of “0” may indicate that the corresponding payload segment was unsuccessfully received. In various implementations, the payload segments 814, 816, 818, 820 may correspond to indicators that have the same position or sequence within the acknowledgement 830. For example, the first payload segment 814 may correspond to the first one-bit indicator in the acknowledgement 830, the second payload segment 816 may correspond to the second one-bit indicator in the acknowledgment 830, the third payload segment 818 may correspond to the third one-bit indicator in the acknowledgement 830, and the 16th payload segment 820 may correspond to the final, 16th one-bit indicator in the acknowledgment 830. The acknowledgement 830 may be used by the computing device that transmitted the audio transmission 800 to determine which payload segments need to be retransmitted. For example, the 6th indicator and the 12th indicator have values of “0”, indicating that the 6th and 12th payload segments were not successfully received. Accordingly, based on the acknowledgement 830, the computing device may determine that the 6th and 12th payload segments need to be transmitted again.

In practice, implementations of the acknowledgement 830 may differ. For example, various implementations of the acknowledgement 830 may use more than one bit to indicate the status of corresponding payload segments. Additionally or alternatively, the acknowledgement 830 may be implemented as multiple acknowledgments, which may be separately transmitted within multiple audio transmissions. In still further implementations, the acknowledgement 830 may not contain indicators of successfully-received payload segments. For example, the acknowledgement 830 may be generated to contain identifiers only of payload segments that were not successfully received. Additionally or alternatively, the acknowledgement 830 may not be generated to include indicators of unsuccessfully received payload segments. For example, the acknowledgement 830 may be generated to include identifiers only of payload segments that were successfully received.

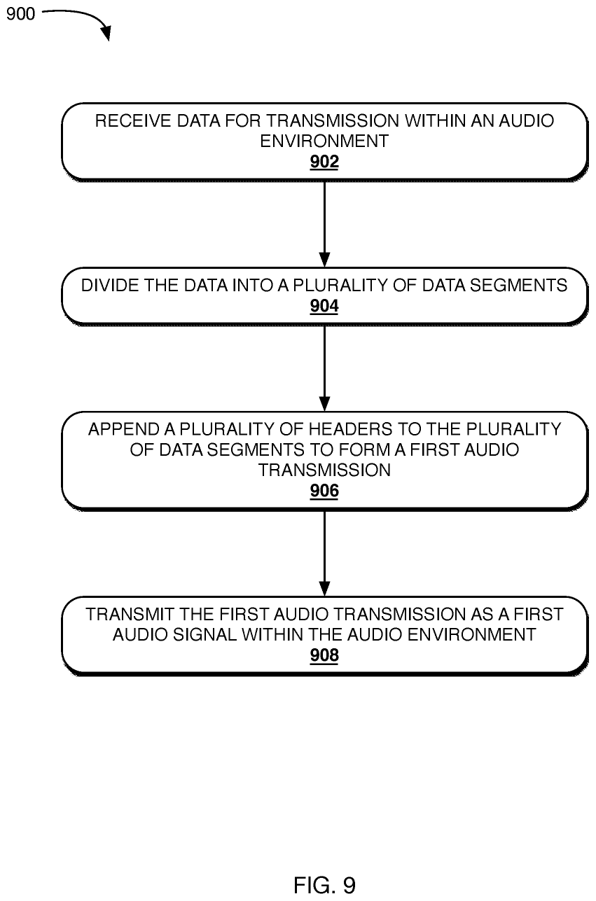

FIG. 9 illustrates a method 900 for transmitting data over audio according to an exemplary embodiment of the present disclosure. The method 900 may be implemented on a computer system, such as the system 600. For example, the method 900 may be implemented by the computing device 602. The method 900 may also be implemented by a set of instructions stored on a computer-readable medium that, when executed by a processor, cause the computing device to perform the method 900. Although the examples below are described with reference to the flowchart illustrated in FIG. 9, many other methods of performing the acts associated with FIG. 9 may be used. For example, the order of some of the blocks may be changed, certain blocks may be combined with other blocks, one or more of the blocks may be repeated, and some of the blocks may be optional.

The method 900 may begin with receiving data for transmission within an audio environment (block 902). For example, the computing device 602 may receive data 608, 702 for transmission within an audio environment surrounding the computing device 602. The audio environment may contain both the computing device 602 and the computing device 604 and/or may contain one or more additional computing devices. The computing device 602 may receive and/or generate the data 608, 702 as part of creating a request for a service.

The data may be divided into a plurality of data segments (block 904). For example, the computing device 602 may divide the data 608, 702 into a plurality of data segments 610, 704, 706, 708. In various implementations, the data 608, 702 may be divided into the data segments 610, 704, 706, 708 based on one or more of a predetermined segment size and/or a predetermined number of data segments, as discussed above. Furthermore, the data 608, 702 may be divided into the data segments 610, 704, 706, 708 upon determining that the size of the data 608, 702 is greater than a predetermined threshold (e.g., 128 bytes, 256 bytes, 512 bytes, 1 kilobyte).

A plurality of headers may be appended to the plurality of data segments to form a first audio transmission (block 906). For example, the computing device 602 may append a plurality of headers 620A, 718, 720, 722 to the plurality of data segments 610, 704, 706, 708 to form a first audio transmission 614A, 716. In particular, the computing device 602 may append a main header 718 and one or more segment headers 720, 722 to the plurality of data segments 610, 704, 706, 708. As explained further above, the main header 718 may be generated to indicate that the first audio transmission 614A, 716 contains a segmented payload. For example, the main header 718 may contain a segment length 724 and/or a segment count 726 for the audio transmission 614A, 716. The segment headers 720, 722 may be generated to individually identify one or more corresponding payload segments 624A, 710, 712, 714 within the audio transmission 614A, 716. In particular, the payload segments 624A, 710, 712, 714 may be generated based on the corresponding data segments 610, 704, 706, 708, as explained above. Furthermore, the segment headers 720, 722 may contain one or more training sequences, which may be used to equalize the received payload segments 624A, 710, 712, 714. In certain implementations, the main header 718 may be appended to the beginning of the audio transmission 716 (e.g., at the beginning of a payload portion of the audio transmission 716). Segment headers 720, 722 may be appended between adjacent pairs of payload segments 624A, 710, 712, 714. Stated differently, segment headers may be appended before each of at least a subset of the payload segments 624A, 710, 712, 714. In certain instances, a segment header may be appended before a first payload segment 710 of the audio transmission 716. In additional or alternative implementations, the first segment header may be omitted (and its contents may be included within the main header 718).

The first audio transmission may be transmitted as a first audio signal within an audio environment (block 908). For example, the computing device 602 may generate and transmit an audio signal containing the audio transmission 614A, 716 within an audio environment containing the computing device 602 and the computing device 604. To generate the audio signal, the computing device 602 may modulate the contents of the audio transmission 614A, 716 (e.g., according to a modulation protocol) to generate a plurality of audio symbols. The audio symbols may be converted into a corresponding audio signal (e.g., an audio signal generated to comply with one or more magnitudes, phases, frequencies, and/or phase differences specified by the audio symbols).

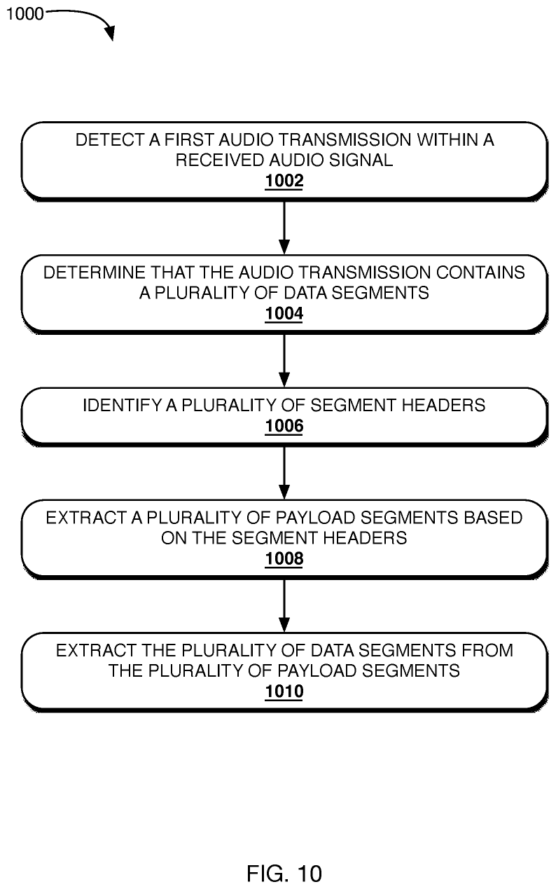

FIG. 10 illustrates a method 1000 for receiving data over audio according to an exemplary embodiment of the present disclosure. The method 1000 may be implemented on a computer system, such as the system 600. For example, the method 1000 may be implemented by the computing device 604. The method 1000 may also be implemented by a set of instructions stored on a computer-readable medium that, when executed by a processor, cause the computing device to perform the method 1000. Although the examples below are described with reference to the flowchart illustrated in FIG. 10, many other methods of performing the acts associated with FIG. 10 may be used. For example, the order of some of the blocks may be changed, certain blocks may be combined with other blocks, one or more of the blocks may be repeated, and some of the blocks may be optional.

The method 1000 begins with detecting an audio transmission within an audio signal received from an audio environment (block 1002). For example, the computing device 604 may detect an audio transmission 614B, 717 within an audio signal 630 received from an audio environment surrounding the computing device 604. For example, the computing device 604 may include one or more audio receivers configured to continuously receive audio signals 630 from a surrounding audio environment. The computing device 604 may monitor the audio signals 630 captured by the audio receivers for audio transmissions and may detect the received audio transmission 614B, 717 within the audio signal 630. For example, the computing device 604 may detect a predetermined portion within the audio signal 630 and may, based on the predetermined portion, determine that the audio signal 630 contains an audio transmission 614B, 717. The audio transmission may be extracted from the audio signal. For example, the computing device 604 may extract the audio transmission from the audio signal 630. In particular, the computing device 604 may identify, based on when the audio transmission 614B, 717 is detected within the audio signal 630, a portion of the audio signal 630 that contains the audio transmission 614B, 717. For example, the computing device 604 may identify, based on when the predetermined portion is detected, a portion of the audio signal 630 that contains the audio transmission 614B. The identified portion of the audio signal 630 may then be extracted from the audio signal (e.g., copied for further processing).

It may then be determined that the audio transmission contains a plurality of data segments (block 1004). For example, the computing devices 604 may determine that the audio transmission 614B, 717 contains a plurality of data segments 610, 704, 706, 708. In particular, the computing device 604 may analyze a portion of the audio signal corresponding to a main header 718 of the audio transmission 614B, 717 and may determine, based on the contents of the main header 718, that the audio transmission 614B, 717 contains a segmented payload. For example, the main header 718 may contain one or more of a segmented payload identifier, a segment length 724, and/or a segment count 726. Based on the presence of one or more of these items, the computing device 604 may determine that the audio transmission 614B, 717 contains a segmented payload.

A plurality of segment headers may be identified (block 1006). For example, the computing device 604 may identify a plurality of segment headers 720, 722 within the received audio transmission 614B, 717. The segment headers 720, 722 may be identified based on information contained within a main header 718 of the audio transmission 614B, 717. For example, the main header 718 may indicate the segment length 724 of payload segments 624B, 710, 712, 734 within the received audio transmission 717. Timestamps for the segment headers 720, 722 may be determined based on the segment length 724 and a predetermined length for the segment headers 720, 722. Additionally or alternatively, the segment headers 720, 722 may be identified based on a training sequence or other predetermined portion contained within the segment headers 720, 722. The computing device 604 may be configured to analyze the received audio signal 630, 732 to identify the training sequence or other predetermined portion. The computing device 604 may accordingly identify, based on detecting the training sequence or other predetermined portion, that a segment header 720, 722 is located at the detected timestamp.

A plurality of payload segments may be extracted based on the segment headers (block 1008). For example, the computing device 604 may extract a plurality of payload segments 624B, 710, 712, 734 based on the segment headers 720, 722 and/or the main header 718. For example, the computing device 604 may extract portions of the audio signal 630, 632 that contain the payload segments 624B, 710, 712, 734 (e.g., as portions of the audio signals 630, 732 that occur between consecutive segment headers). In particular, the computing device 604 may be configured to extract the audio signal segments 736, 738, 740, as discussed above. In certain implementations, the payload segments 64B, 710, 712, 734 may be extracted with the corresponding headers (e.g., main headers 718, segment headers 720, 722).

The plurality of data segments may be extracted from the plurality of payload segments (block 1010). For example, the computing device 604 may extract a plurality of data segments 612, 704, 706, 742 from the payload segments 624B, 710, 712, 734. In certain implementations, extracting the data segments 612, 704, 706, 742 may include equalizing portions of the audio signal (e.g., the audio signal segments 736, 738, 740) to correct for one or more forms of audio interference it effectively received from audio transmission 717. In particular, the payload segments 710, 712, 734, 624B may be equalized based on training sequences contained within corresponding headers (e.g., the main header 718, segment headers 720, 722). Furthermore, as explained above, one or more error detection and correction operations may be performed on the extracted data segments 704, 706, 742, 612 based on error detection and correction information contained within the payload segments 710, 712, 734, 624B and/or the headers 620B, 718, 720, 722. In certain instances, the computing device 604 may determine, based on the error detection and correction operation, that one or more of the data segments 742 were not properly received.

After extracting the data segments 612, 704, 706, 742, the computing device 604 may generate a second audio transmission 616 that contains an acknowledgment 626. In certain instances, the second audio transmission may be generated to request retransmission of at least one of the plurality of data segments 742 that were not properly received. For example, the acknowledgement 626 may identify one or both of the data segments 612, 704, 706 that were successfully received within the audio transmission 614B, 717 and data segments 742 that were not successfully received. As a specific example, similar to the acknowledgement 830, the acknowledgement 626 may contain an identifier for one or more of the payload segments 624B, 710, 712, 734.

The computing device 602 may receive the audio transmission 616 and may determine, based on the acknowledgement 626, that one or more of the payload segments 624C need to be retransmitted. For example, the acknowledgement 626 may indicate that the data segment at 708 was not properly received (e.g., because a corrupted data segment 742 was extracted from corresponding payload segment at 734). The computing device 602 may determine, based on the acknowledgment 626, that the data segment 708 needs to be retransmitted. Accordingly, the computing device 602 may construct a third audio transmission 618 that contains the payload segment 708 and may retransmit the audio transmission 618 similar to the audio transmission 614A (e.g., by modulating the contents of the audio transmission 618 into a plurality of audio symbols that are converted into an analog audio signal). In implementations where more than one payload segment needs to be retransmitted, the third audio transmission 618 may be generated similar to the first audio transmission 614A, 716. In particular, the third audio transmission 618 may contain a plurality of payload segments and one or more of the payload segments may have corresponding segment headers. In certain instances, the computing device 604 may still not have properly received all of the data segments. For example, one of the data segments extracted from the received audio transmission 618 may contain an error that cannot be corrected. In such instances, the computing device 604 may transmit another audio transmission containing another acknowledgement, and the retransmission procedure may be repeated until all data segments are properly received. Once received, the computing device 604 may combine the data segments to reconstitute the data intended for transmission.

In this way, the methods 900, 1000 enable the segmented transmission of large data payloads over audio transmissions. Segmented data transmission may improve the reliability of data transmission for large data payloads. In particular, the inclusion of segment headers may ensure that, even if different types of audio interference affect different portions of the same audio transmission, these sources of interference can be corrected by a receiving computing device on a per-segment basis. Furthermore, transmitting data using segmented audio payloads reduces the need and magnitude for data to be retransmitted. In particular, as explained above, the receiving computing device may be able to determine specifically which data segments were not properly received and may only need to request retransmission of those data segments. This removes the need to retransmit the entire data payload, freeing up communication bandwidth and reducing overall data transmission time.

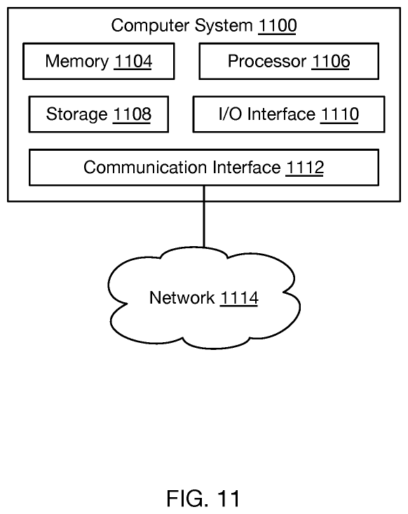

FIG. 11 illustrates an example computer system 1100 that may be utilized to implement one or more of the devices and/or components discussed herein, such as the computing devices 102, 104, 302, 304, 402, 404, 410, 504, 602, 604, the server devices 510, 512, and/or the merchant device 506. In particular embodiments, one or more computer systems 1100 perform one or more steps of one or more methods described or illustrated herein. In particular embodiments, one or more computer systems 1100 provide the functionalities described or illustrated herein. In particular embodiments, software running on one or more computer systems 1100 performs one or more steps of one or more methods described or illustrated herein or provides the functionalities described or illustrated herein. Particular embodiments include one or more portions of one or more computer systems 1100. Herein, a reference to a computer system may encompass a computing device, and vice versa, where appropriate. Moreover, a reference to a computer system may encompass one or more computer systems, where appropriate.

This disclosure contemplates any suitable number of computer systems 1100. This disclosure contemplates the computer system 1100 taking any suitable physical form. As an example and not by way of limitation, the computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1106, memory 1104, storage 1108, an input/output (I/O) interface 1110, and a communication interface 1112. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 1106 includes hardware for executing instructions, such as those making up a computer program. As an example and not by way of limitation, to execute instructions, the processor 1106 may retrieve (or fetch) the instructions from an internal register, an internal cache, memory 1104, or storage 1108; decode and execute the instructions; and then write one or more results to an internal register, internal cache, memory 1104, or storage 1108. In particular embodiments, the processor 1106 may include one or more internal caches for data, instructions, or addresses. This disclosure contemplates the processor 1106 including any suitable number of any suitable internal caches, where appropriate. As an example and not by way of limitation, the processor 1106 may include one or more instruction caches, one or more data caches, and one or more translation lookaside buffers (TLBs). Instructions in the instruction caches may be copies of instructions in memory 1104 or storage 1108, and the instruction caches may speed up retrieval of those instructions by the processor 1106. Data in the data caches may be copies of data in memory 1104 or storage 1108 that are to be operated on by computer instructions; the results of previous instructions executed by the processor 1106 that are accessible to subsequent instructions or for writing to memory 1104 or storage 1108; or any other suitable data. The data caches may speed up read or write operations by the processor 1106. The TLBs may speed up virtual-address translation for the processor 1106. In particular embodiments, processor 1106 may include one or more internal registers for data, instructions, or addresses. This disclosure contemplates the processor 1106 including any suitable number of any suitable internal registers, where appropriate. Where appropriate, the processor 1106 may include one or more arithmetic logic units (ALUs), be a multi-core processor, or include one or more processors 1106. Although this disclosure describes and illustrates a particular processor, this disclosure contemplates any suitable processor.

In particular embodiments, the memory 1104 includes the main memory for storing instructions for the processor 1106 to execute or data for processor 1106 to operate on. As an example, and not by way of limitation, computer system 1100 may load instructions from storage 1108 or another source (such as another computer system 1100) to the memory 1104. The processor 1106 may then load the instructions from the memory 1104 to an internal register or internal cache. To execute the instructions, the processor 1106 may retrieve the instructions from the internal register or internal cache and decode them. During or after execution of the instructions, the processor 1106 may write one or more results (which may be intermediate or final results) to the internal register or internal cache. The processor 1106 may then write one or more of those results to the memory 1104. In particular embodiments, the processor 1106 executes only instructions in one or more internal registers or internal caches or in memory 1104 (as opposed to storage 1108 or elsewhere) and operates only on data in one or more internal registers or internal caches or in memory 1104 (as opposed to storage 1108 or elsewhere). One or more memory buses (which may each include an address bus and a data bus) may couple the processor 1106 to the memory 1104. The bus may include one or more memory buses, as described in further detail below. In particular embodiments, one or more memory management units (MMUs) reside between the processor 1106 and memory 1104 and facilitate accesses to the memory 1104 requested by the processor 1106. In particular embodiments, the memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory implementations, this disclosure contemplates any suitable memory implementation.

In particular embodiments, the storage 1108 includes mass storage for data or instructions. As an example and not by way of limitation, the storage 1108 may include a hard disk drive (HDD), a floppy disk drive, flash memory, an optical disc, a magneto-optical disc, magnetic tape, or a Universal Serial Bus (USB) drive or a combination of two or more of these. The storage 1108 may include removable or non-removable (or fixed) media, where appropriate. The storage 1108 may be internal or external to computer system 1100, where appropriate. In particular embodiments, the storage 1108 is non-volatile, solid-state memory. In particular embodiments, the storage 1108 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1108 taking any suitable physical form. The storage 1108 may include one or more storage control units facilitating communication between processor 1106 and storage 1108, where appropriate. Where appropriate, the storage 1108 may include one or more storages 1108. Although this disclosure describes and illustrates particular storage, this disclosure contemplates any suitable storage.

In particular embodiments, the I/O Interface 1110 includes hardware, software, or both, providing one or more interfaces for communication between computer system 1100 and one or more I/O devices. The computer system 1100 may include one or more of these I/O devices, where appropriate. One or more of these I/O devices may enable communication between a person (i.e., a user) and computer system 1100. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 1110 may include one or more device or software drivers enabling processor 1106 to drive one or more of these I/O devices. The I/O interface 1110 may include one or more I/O interfaces 1110, where appropriate. Although this disclosure describes and illustrates a particular I/O interface, this disclosure contemplates any suitable I/O interface or combination of I/O interfaces.

In particular embodiments, communication interface 1112 includes hardware, software, or both providing one or more interfaces for communication (such as, for example, packet-based communication) between computer system 1100 and one or more other computer systems 1100 or one or more networks 1114. As an example and not by way of limitation, communication interface 1112 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 1114 and any suitable communication interface 1112 for the network 1114. As an example and not by way of limitation, the network 1114 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network, or a combination of two or more of these. Computer system 1100 may include any suitable communication interface 1112 for any of these networks, where appropriate. Communication interface 1112 may include one or more communication interfaces 1112, where appropriate. Although this disclosure describes and illustrates a particular communication interface implementations, this disclosure contemplates any suitable communication interface implementation.

The computer system 1102 may also include a bus. The bus may include hardware, software, or both and may communicatively couple the components of the computer system 1100 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
receiving data for transmission within an audio environment;
dividing the data into a plurality of data segments;
appending a plurality of headers to the plurality of data segments to form a first audio transmission; and
transmitting the first audio transmission as a first audio signal within the audio environment.

2. The method of claim 1, further comprising, after transmitting the first audio transmission:
receiving, within the audio environment, a second audio transmission containing an acknowledgment of the first audio transmission; and
determining, based on the second audio transmission, that a subset of the plurality of data segments were not received.

3. The method of claim 2, wherein the acknowledgment contains identifiers of received data segments, and wherein the subset of the plurality of data segments that were not received are identified based on the identifiers.

4. The method of claim 3, further comprising:
generating a third audio transmission containing the subset of the plurality of data segments; and
transmitting the third audio transmission as a second audio signal within the audio environment.

5. The method of claim 1, wherein the plurality of headers include a main header before a first data segment of the plurality of data segments and a plurality of segment headers before at least a subset of the plurality of data segments.

6. The method of claim 5, wherein the main header indicates (i) a segment length for the plurality of data segments and/or (ii) a quantity of the plurality of data segments.

7. The method of claim 5, wherein the plurality of segment headers are generated individually for each corresponding segment.

8. The method of claim 7, wherein each segment header of the plurality of segment headers is generated to contain an identifier of a subsequent data segment.

9. The method of claim 7, wherein each segment header of the plurality of segment headers is generated based on a subsequent data segment.

10. The method of claim 1, wherein each of the plurality of headers includes a training sequence.

11. The method of claim 1, wherein transmitting the first audio transmission as a first audio signal comprises:
modulating contents of the first audio transmission into a plurality of audio symbols; and
generating an audio signal containing the plurality of audio symbols.

12. The method of claim 1, wherein a size of the data for transmission is greater than or equal to 256 bytes.

13. A system comprising:
a processor; and
a memory storing instructions which, when executed by the processor, cause the processor to:
receive data for transmission within an audio environment;
divide the data into a plurality of data segments;
append a plurality of headers to the plurality of data segments to form a first audio transmission; and
transmit the first audio transmission as a first audio signal within the audio environment.

14. A method comprising:
detecting a first audio transmission within a received audio signal;
determining, based on a main header of the first audio transmission, that the audio transmission contains a plurality of data segments;
identifying, within the first audio transmission, a plurality of segment headers;
extracting, from the received audio signal, a plurality of payload segments based on the segment headers; and
extracting, based on the segment headers, the plurality of data segments from the plurality payload segments.

15. The method of claim 14, wherein extracting the plurality of data segments comprises:
determining that at least one of the plurality of data segments was not properly received; and
transmitting a second audio transmission requesting retransmission of the at least one of the plurality of data segments that was not properly received.

16. The method of claim 15, wherein the second audio transmission contains an acknowledgment, and wherein the method further comprises generating the acknowledgment to include identifiers of data segments of the plurality of data segments that were properly received.

17. The method of claim 15, further comprising receiving a third audio transmission that contains the at least one of the plurality of data segments that was not properly received.

18. The method of claim 14, wherein the main header indicates a segment length for the plurality of data segments and/or a quantity of the plurality of data segments.

19. The method of claim 14, wherein each of the plurality of headers includes a training sequence.

20. The method of claim 19, wherein the plurality of segment headers are identified based on the training sequence.

21. The method of claim 19, wherein extracting the data from the plurality of payload segments comprises equalizing the plurality of payload segments based on a preceding segment header.

22. The method of claim 14, wherein the plurality of payload segments are extracted as portions of the audio signal between consecutive segment headers.

23. The method of claim 14, wherein the plurality of payload segments are extracted to include corresponding segment headers.
